(19) United States
(12) Patent Application Publication
(10) Pub. No.: US 2010/0176326 A1
(43) Pub. Date: Jul. 15, 2010

(54) INTEGRALLY-FORMED VALVE HAVING A VALVE MEMBER PROVIDED WITH A SPHERICAL BEARING SURFACE

(76) Inventors: Dominique Moison, St. Pantaleon Les Vignes (FR); Thierry Mailhan, Valreas (FR)

Correspondence Address: CLARK & BRODY, 1700 Diagonal Road, Suite 510, Alexandria, VA, 22314, US

(21) Appl. No.: 12/593,680

(22) PCT Filed: Mar. 28, 2008
(86) PCT No.: PCT/FR08/50550

§ 371 Date: Mar. 29, 2010

(30) Foreign Application Priority Data
Mar. 30, 2007 (FR) 0754182

(51) Int. Cl. F16K 31/44

(52) U.S. Cl. 251/235

(57) ABSTRACT

The invention relates to a valve including an integrally formed body having a first coupling segment and a second coupling segment defining bores, one of which bores has a right cross-section that is larger than the right cross-section of the other bore, and the bores being interconnected to define an abutment shoulder for a separately mounted seat against which a valve member having a spherical bearing surface is suitable for co-operating, which valve member is caused to pivot by a lever to close off the bores in leaktight manner or to open them at least in part, the seat having dimensions adapted to it being inserted via the coupling segment to the shoulder so as then to be held thereagainst by holding means. According to the invention, the seat is held in abutment against the shoulder by means of the snap-fastening type.

The present invention relates to the technical field of valves or taps in the general sense, and relates more precisely to valves that, inside a body, have a valve member that is provided with a spherical bearing surface and that is caused to pivot to close or to open a passage for a fluid.

In a preferred example of use, the invention relates to a valve designed to be fastened to a tank and whose valve member provided with a spherical bearing surface is a vane. Vane valves are well known in the state of the art and can be made of various materials and using various methods that substantially involve the same structure.

A vane valve has a main casing defining a chamber communicating with upstream and downstream coupling segments for connecting to pipes or the like. The main casing is generally open to give access to the chamber that is closed by a cap or the like that centers a cylindrical stem extending outside the cap so as to be constrained in rotation with an operating lever. The cylindrical stem is extended inside the chamber to an offset or off-center vane that is designed to co-operate with a seat or with a sealing gland that is mounted in the chamber prior to closing the casing with the cap.

Such a valve makes it possible to perform an opening or a closure function for opening or closing, in particular, a tank on which the valve is mounted. In certain uses, such a tank equipped with such a valve is placed inside a container designed to be completely closed while it is being transported. Unfortunately, the valve that extends in a manner such that it projects relative to the tank requires use of a container that is of dimensions larger than the dimensions of the tank in order to accommodate the length of the valve. As a result, the volume of substance transported in the tank is less than the volume of the container, which gives rise to wastage and to increased transport cost. In order to limit the impact of this drawback, the dimensions between the tank and the container are reduced to the limit, thereby frequently giving rise to the valve being damaged on closing the container.

In the field of valves having spherical valve members, Document GB 892 599 also discloses a valve having a body in which two bores are provided that, between them, define an abutment shoulder against which a spherical valve member is suitable for co-operating, which valve member is caused to pivot by a lever to close off the bores in leaktight manner or to open them at least in part. It transpires that the way such a seat is mounted does not make it possible to guarantee good closure leaktightness.

Similarly, Document GB 2 231 640 describes a valve with a spherical valve member held in abutment against a sealing seat by means of a spring system. That valve does not make it possible to guarantee good closure leaktightness and it is complex to implement.

An object of the present invention is therefore to remedy the above-mentioned drawbacks by proposing a novel valve that includes a valve member having a spherical bearing surface and that is designed to have a limited length while also offering good leaktightness and the possibility of being connected both upstream and downstream.

Another object of the invention is to provide a valve that offers the advantage of being suitable for being manufactured by molding a suitable plastics material, thereby making low-cost mass production possible.

To achieve these objects, the invention provides a valve including an integrally formed body having a first coupling segment and a second coupling segment defining bores, one of which bores has a right cross-section that is larger than the right cross-section of the other bore, and the bores being interconnected to define an abutment shoulder for a separately mounted seat against which a valve member having a spherical bearing surface is suitable for co-operating, which valve member is caused to pivot by a lever to close off the bores in leaktight manner or to open them at least in part, the seat having dimensions adapted to it being inserted via the coupling segment to the shoulder so as then to be held thereagainst by holding means.

According to the invention, the seat is held in abutment against the shoulder by means of the snap-fastening type.

Advantageously, the seat is made of a deformable material enabling it to be mounted in the bore by snap-fastening.

In this variant embodiment, the holding means of the snap-fastening type are implemented by lugs that are spaced apart angularly while being provided in the bore of the coupling segment, so as to define, with the shoulder, a groove for receiving the seat.

Preferably, the sealing seat defines an annular peripheral band suitable for deforming to pass over the lugs so as then to engage in the groove.

In another variant embodiment, the sealing seat is provided with lugs suitable for engaging in recesses provided in the bore.

Advantageously, the seat bears against a sealing gasket mounted inside an annular groove provided in the shoulder.

It should be noted that the valve member having a spherical bearing surface is a vane valve member.

Preferably, the vane valve member is made of a polycarbonate material.

According to a characteristic of the invention, one of the coupling segments is equipped with connection means for connection to a tank while the other coupling segment is equipped with connection means for connection to a pipe and to a stopper.

Preferably, the integrally formed body is made of a molded plastics material.

Various other characteristics appear from the following description given with reference to the accompanying drawings which show embodiments of the invention by way of non-limiting example, and in which:

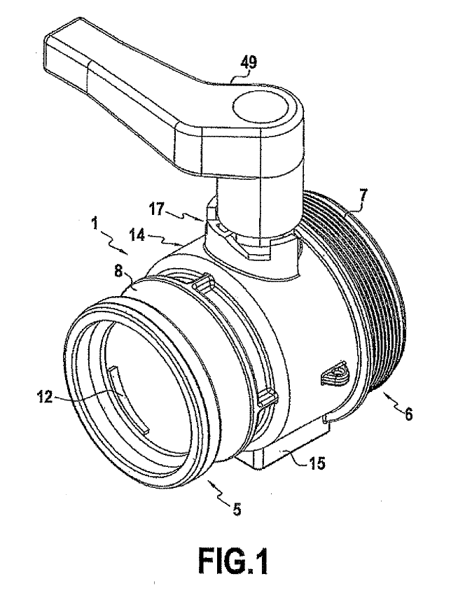

FIG. 1 is a perspective view showing an embodiment of a valve of the invention;

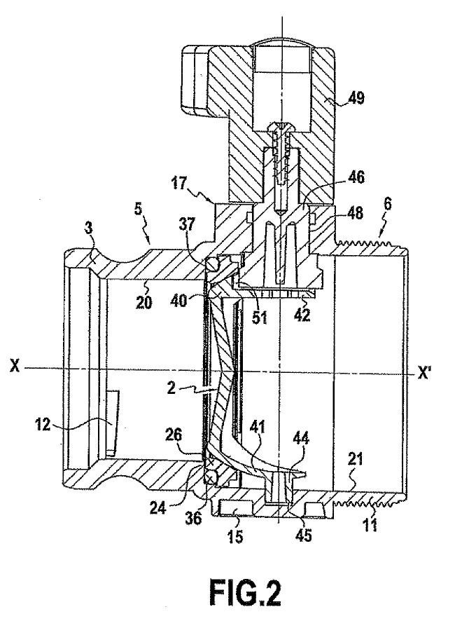

FIG. 2 is an elevation view of the valve of the invention in the closed position;

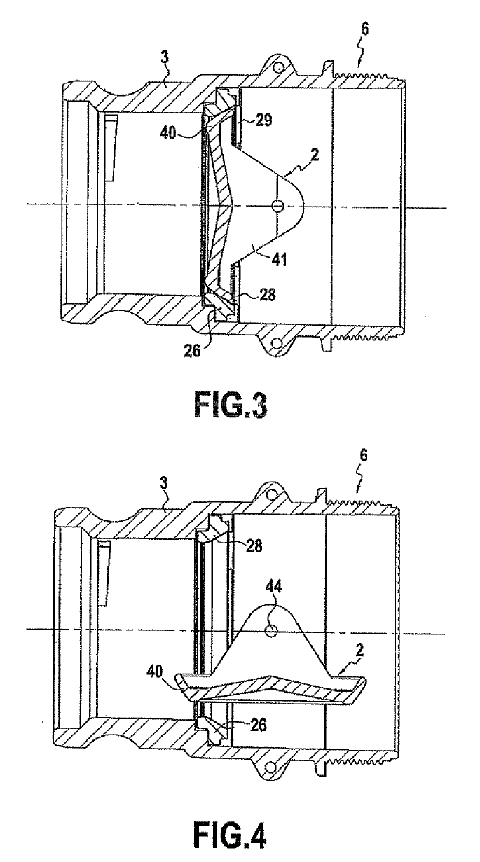

FIG. 3 is a section view substantially on line X-X′ of FIG. 2;

FIG. 4 is a view of the valve that is analogous to the FIG. 3 view, but with the valve being shown with its valve member in the open position;

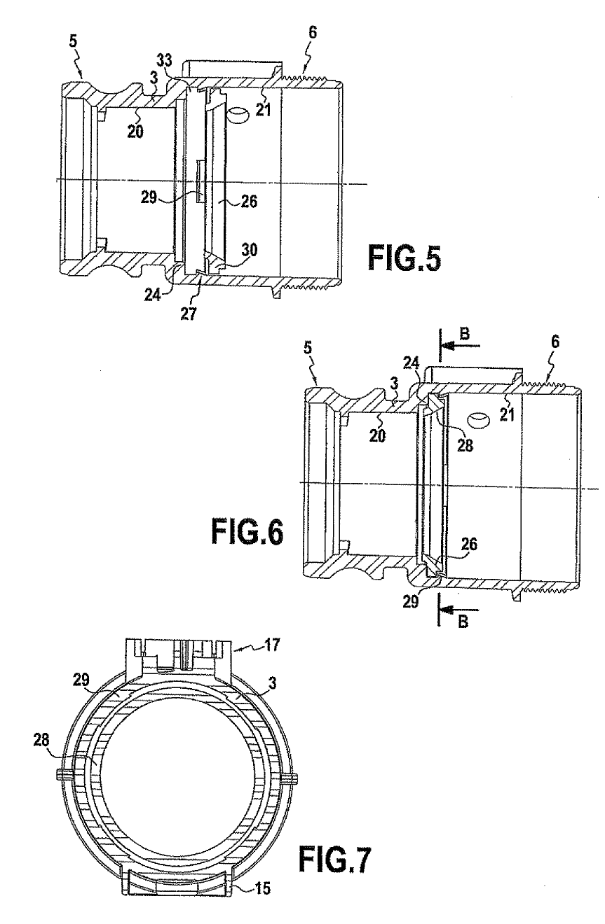

FIGS. 5 and 6 are elevation views showing two characteristic stages in mounting the seat in the valve body; and

FIG. 7 is a cross-section view substantially on line B-B of FIG. 6.

As appears more precisely from FIGS. 1 to 7, the invention relates to a valve 1 having a valve member 2 that is provided with a spherical bearing surface and that is formed by a vane. The valve 1 has a casing or a body 3 advantageously made in one piece or integrally. The body 3 is made of suitable plastics material by molding. The material chosen can, for example, be polypropylene.

The body 3 is formed to present a first coupling segment 5 and a second coupling segment 6 also referred to as input and output or upstream and downstream coupling segments in view of the direction of flow of any fluid inside a circuit in which the valve is mounted. Both of the coupling segments 5 and 6 have generally cylindrical shapes that are aligned with each other. For example, one of the coupling segments 6 is equipped with connection means 7 for connection to a tank (not shown), while the other coupling segment 5 is equipped with connection means 8 for connection to a pipe or the like. For example, the connection means 7 are implemented by a thread provided externally on a collar 11, from the free end of the second coupling segment 6. The connection means 8 with which the first coupling segment 5 is equipped are constituted by an annular assembly groove provided in its peripheral surface for quick connection.

According to a preferred implementation characteristic, said first coupling segment 5 is also provided with mount means 12 for mounting a stopper. As shown more precisely in FIGS. 1 and 2, the coupling segment 5 is internally provided with mount means 12 of the bayonet type for receiving an internal stopper.

The second coupling segment 6 is connected to the first coupling segment 5 via a central interconnection portion 14 extending the collar 11. This central interconnection portion 14 has a flat bottom 15 situated opposite from an annular projecting rim 17.

The first coupling segment 5 internally defines a bore 20 of circular right cross-section opening out into a bore 21 defined by the inside of the second coupling segment 6. The bores 20 and 21 are mutually aligned so that they extend along a common longitudinal axis X, X′. The bore 21 has a right cross-section that is larger than the right cross-section of the bore 20 of the first coupling segment 2. The bores 20 and 21 of the coupling segments 5 and 6 are interconnected to define an abutment shoulder 24 for a sealing seat 26 on which the valve member 2 is suitable for co-operating. The abutment shoulder 24 thus presents a surface that is transverse relative to the direction of flow of the fluid that takes place in the direction X-X′.

According to another characteristic of the invention, the seat 26 has dimensions that are adapted to it being inserted from the second coupling segment 6 to the shoulder 24 so as to be retained thereagainst by holding means 27. As can be seen more precisely in FIGS. 5 and 6, the dimensions of the seat 26 are thus, ignoring clearance, less than or equal to the dimensions of the bore 21 so as to make it possible to insert the seat and to move it to the shoulder 24. In the example shown, the seat 26 is in the form of a ring having, on its inside diameter, a spherical bearing surface 28 that is, for example, of convex shape adapted to co-operate with the valve member 2 to guarantee leaktight closure of the valve. Naturally, the spherical bearing surface 28 can present a different shape, e.g. a concave shape.

As shown in FIGS. 1 to 7, the holding means 27 are holding means of the snap-fastening type. It should be considered that the seat 26 is made of a deformable material enabling it to be mounted by snap-fastening in the bore 21. These holding means of the snap-fastening type are implemented by fingers or lugs 29 provided in the bore 21 in angularly spaced-apart manner. For example, the bore 21 of the first coupling segment 6 has four lugs 29 spaced apart by 90°. The seat 26 defines an annular peripheral band 30 suitable for deforming to pass over the fingers or lugs 29 so as then to engage in a groove 33 defined between the shoulder 24 and the lugs. The seat 26 thus finds itself between the shoulder 24 and the lugs 29. The sealing seat 26 is made of a material enabling it to deform, thereby allowing it to be mounted by snap-fastening. Preferably, the seat 26 is made of polycarbonate. Naturally, it is possible to implement the holding means of the snap-fastening type differently. For example, it is possible to provide the sealing seat 26 with lugs suitable for engaging in recesses provided in the bore 21.

In a preferred embodiment shown in FIG. 2, the seat 26 bears against a sealing gasket 36 mounted inside an annular groove 37 provided in the shoulder 24. Said sealing gasket 36 makes it possible to provide sealing between the body 3 and the seat 26. It should be noted that the presence of the sealing gasket 36 made of a deformable material facilitates locking in the direction X-X′ of the seat 26 held on one side in direct contact with the lugs 29 and on the other side in indirect contact with the shoulder 24 via the sealing gasket 36.

According to another characteristic of the invention, the valve member 2 is mounted inside the valve by being inserted via the second coupling segment 6. The valve member 2 thus has dimensions smaller than the dimensions of the bore 21. In the embodiment in which the valve member is a vane valve member, said valve member is substantially U-shaped in cross-section, with a web 40 extended by two substantially parallel side branches 41 and 42. The branch 41 is provided with a pivot 44 suitable for being inserted into a bearing 45 formed by a setback provided in the bottom 15 of the valve. The branch 42 is designed to be connected to a rotary stem 46 that is guided in rotation in a bore 48 provided in a projecting rim 17 along an axis perpendicular to the longitudinal axis X, X′ of the valve and opening out outside the body 3 and inside the bore 21. The rotary stem 46 is mounted in leaktight manner in the body 3 and extends projecting outside the rim 17 to be constrained in rotation by any suitable means with an operating lever 49.

The web 40 constituting the vane of the valve member is thus offset relative to its axis of rotation centered in the body of the valve. Via its outside face, the web 40 presents a cylindrical-portion shape adapted to co-operate, in the valve closure position, with the bearing surface 28 of the seat 26 (FIG. 2 and FIG. 3). By rotating through one quarter of a turn, the lever 49 disengages the vane 40 which then comes into a plane that is substantially parallel to the axis X, X′ (FIG. 4). In this position, the valve 1 is open.

Preferably, the top branch 42 of the vane is provided with a through hole 51 adapted to enable the end of the stem 46 to be inserted through it. The valve member 2 is then turned through one half-turn so as to lock the top branch 42 in rotation with the stem 46 with a view to coupling the valve member 2 to the lever 49.

It appears from the above description that the invention makes it possible to limit the number of parts of the valve by implementing a body 3 that is formed integrally or in one piece. Mounting the seat 26 inside the valve does not require any additional part. Such a configuration makes it possible to obtain a compact valve having a limited length.

The invention is not limited to the examples described and shown because various modifications can be made to it without going beyond its ambit.

1. A valve including an integrally formed body (3) having a first coupling segment (5) and a second coupling segment (6) defining bores (20, 21), one of which bores (21) has a right cross-section that is larger than the right cross-section of the other bore (20), and the bores being interconnected to define an abutment shoulder (24) for a separately mounted seat (26) against which a valve member (2) having a spherical bearing surface is suitable for co-operating, which valve member is caused to pivot by a lever (49) to close off the bores in leaktight manner or to open them at least in part, the seat (26) having dimensions adapted to it being inserted via the coupling segment (6) to the shoulder (24) so as then to be held thereagainst by holding means (27), said valve being characterized in that the seat (26) is held in abutment against the shoulder (24) by means of the snap-fastening type (29).

2. A valve according to claim 1, characterized in that the seat (26) is made of a deformable material enabling it to be mounted in the bore (21) by snap-fastening.

3. A valve according to claim 1, characterized in that the holding means of the snap-fastening type (29) are implemented by lugs that are spaced apart angularly while being provided in the bore (21) of the coupling segment (6), so as to define, with the shoulder (24), a groove (33) for receiving the seat (26).

4. A valve according to claim 3, characterized in that the sealing seat defines an annular peripheral band (30) suitable for deforming to pass over the lugs (29) so as then to engage in the groove (33).

5. A valve according to claim 2, characterized in that the sealing seat (26) is provided with lugs suitable for engaging in recesses provided in the bore (21).

6. A valve according to claim 1, characterized in that the seat (26) bears against a sealing gasket (36) mounted inside an annular groove (37) provided in the shoulder (24).

7. A valve according to claim 1, characterized in that the valve member (2) having a spherical bearing surface (2) is a vane valve member.

8. A valve according to claim 7, characterized in that the vane valve member (2) is made of a polycarbonate material.

9. A valve according to claim 1, characterized in that one of the coupling segments (6) is equipped with connection means (7) for connection to a tank while the other coupling segment (5) is equipped with connection means (8, 12) for connection to a pipe and to a stopper.

10. A valve according to claim 1, characterized in that the integrally formed body (3) is made of a molded plastics material.

11. A valve according to claim 2, characterized in that the holding means of the snap-fastening type (29) are implemented by lugs that are spaced apart angularly while being provided in the bore (21) of the coupling segment (6), so as to define, with the shoulder (24), a groove (33) for receiving the seat (26).
